(19) United States
(12) Patent Application Publication
(10) Pub. No.: US 2012/0314144 A1
(43) Pub. Date: Dec. 13, 2012

(54) DISPLAY DEVICE

(76) Inventors: Tatsuya Sugita, Takahagi (JP); Miyuki Sugita, Takahagi (JP); Masanori Yuuki, Oamishirasato (JP); Shinichiro Oka, Hitachi (JP); Toshio Miyazawa, Chiba (JP); Terunori Saitou, Mobara (JP)

(21) Appl. No.: 13/490,610

(22) Filed: Jun. 7, 2012

(30) Foreign Application Priority Data
Jun. 7, 2011 (JP) 2011-127002

(51) Int. Cl. G02F 1/1335

(52) U.S. Cl. 349/15

(57) ABSTRACT

A display device, having: a display panel; and a liquid crystal lens panel for switching a 2D display and a 3D display with each other, and for forming a parallax barrier by controlling the refractive index as in a cylindrical lens, wherein the liquid crystal lens panel has: a pair of transparent substrates; comb-shaped electrodes, which are formed on the liquid crystal layer side of one of the transparent substrates, run in the X direction and are aligned in the Y direction; flat common electrodes; and post spacers having light transmitting properties for holding the pair of transparent substrates at a predetermined distance, wherein the post spacers are fixed to one of the pair of transparent substrates on the liquid crystal side and are placed in regions away from the comb-shaped electrodes in a plane of the transparent substrate.

### CROSS-REFERENCE TO RELATED APPLICATION

The present application claims priority over Japanese application JP 2011-127002 filed on Jun. 7, 2011, the contents of which are hereby incorporated into this application by reference.

### BACKGROUND OF THE INVENTION

(1) Field of the Invention

The present invention relates to a display device, and in particular to a liquid crystal lens type three-dimensional display device where a liquid crystal display panel having a lens function is provided on the display side of a display panel for displaying an image.

(2) Description of the Related Art

Display devices where a two-dimensional (2D) display and a three-dimensional (3D) display, which can be seen with the naked eye, that is to say, without using any glasses, can be switched with each other are formed of, for example, a first liquid crystal display panel for displaying an image and a second liquid crystal display panel that is provided on the display side (viewer side) of the first liquid crystal display panel and forms a parallax barrier for allowing different rays to enter the left and right eyes of the viewer at the time of a 3D display. In these liquid crystal display devices where a 2D display and a 3D display can be switched with each other, the alignment of liquid crystal molecules in the second liquid crystal display panel is controlled so that the refractive index in the second liquid crystal display panel is changed so as to form lens regions (lenticular lens, cylindrical lens array) which run in the upward and downward directions and are aligned in the left and right directions on the display, and thus, light beams from pixels are directed along the visual line so as to correspond to the left and right eyes separately in the configuration.

Liquid crystal lens type three-dimensional display devices having the above-described structure include, for example, the three-dimensional image display device in JP 2010-224191A. This display device in JP 2010-224191A has such a structure that electrodes in comb form are respectively formed on a pair of transparent substrates, upper and lower, which are placed so as to face each other with a liquid crystal layer in between. In this structure, a voltage applied across the electrodes on the upper and lower transparent substrates can be controlled so as to make it possible to switch the 2D display and the 3D display, and at the same time, the parallax number at the time of the 3D display can be controlled.

### SUMMARY OF THE INVENTION

In order for the second liquid crystal display panel to effectively function as a liquid crystal lens, the height (thickness) of the liquid crystal layer, that is to say, the gap between the first substrate (upper transparent substrate) and the second substrate (lower transparent substrate), needs to be approximately 20 μm to 100 μm, and thus, a gap that is wider than that in the first liquid crystal display panel is required. In order to secure such a wide gap, spacer members, such as spacer beads, of which the size is greater than that in the first liquid crystal display panel for displaying an image are required.

In the case where such spacer beads having a large diameter are used as spacer members, a large area is occupied by the spacer beads in a plane in the second liquid crystal display panel, and therefore, the ratio of light that transmits through the spacer beads from among the display light emitted from the first liquid crystal display panel is high. When the display light that has reached a spacer bead enters into or leaves from the spacer bead, the light that transmits after refraction from the interface between the liquid crystal layer and the spacer bead and the light that is reflected from the interface are separated, and the lights are respectively emitted from the second liquid crystal display panel as display light.

In particular, in the second liquid crystal display panel where the 2D display and the 3D display can be switched with each other, the refractive index of the liquid crystal layer is controlled by the electrical field applied across the comb-shaped electrodes and the common electrodes, and thus, a cylindrical lens array is formed. Meanwhile, the refractive index of the spacer beads is inherent to the material that forms the spacer beads, and thus does not change. As a result, when the 2D display and the 3D display are switched with each other, the refractive index in the vicinity of the comb-shaped electrodes changes greatly.

Therefore, the difference in the refractive index between a spacer bead and the liquid crystal layer is great in the case where the spacer bead is placed in the vicinity of a comb-shaped electrode. As a result, the refractive angle and the reflection of the display light are great in the interface between the spacer bead and the liquid crystal layer, which makes light scattering great, and therefore, such a problem arises that the viewer sees the spacer bead, which lowers the display quality. Furthermore, large spacer beads disturb the alignment of the liquid crystal, and thus, there is such a concern that the lens performance may be reduced at the time of the 3D display.

The present invention is provided in light of these problems, and an object of the present invention is to provide a display device where the display quality can be high both at the time of the 2D display and the 3D display.

In order to solve the above-described problems, the display device according to the present invention has: a display panel for displaying an image; and a liquid crystal lens panel for switching a 2D display and a 3D display with each other, which is provided on the display side of the above-described display panel and forms a parallax barrier by controlling the refractive index as in a cylindrical lens, wherein the above-described liquid crystal lens panel has: a pair of transparent substrates that are placed so as to face each other with a liquid crystal layer in between; comb-shaped electrodes, which are formed on the liquid crystal layer side of one of the above-described transparent substrates, run in the X direction, and are aligned in the Y direction; flat common electrodes formed on the liquid crystal layer side of the other of the above-described transparent substrates; and post spacers having light transmitting properties for holding the above-described pair of transparent substrates at a predetermined distance, wherein the above-described post spacers are fixed to one of the above-described pair of transparent substrates on the liquid crystal side and are placed in regions away from the above-described comb-shaped electrodes in a plane of the above-described transparent substrate.

According to the present invention, the display quality at the time of the 2D display and the 3D display can be improved.

The other effects of the present invention will be clarified from the entire description of the specification.

### BRIEF DESCRIPTION OF THE DRAWINGS

FIG. 1 is a cross-sectional diagram for illustrating the entire structure of the liquid crystal display device, which is the display device according to the first embodiment of the present invention;

FIG. 2 is a diagram for illustrating the structure of pixels in the first liquid crystal display panel in the display device according to the first embodiment of the present invention;

FIG. 3 is a plan diagram for illustrating the structure in detail of the second liquid crystal display panel in the display device according to the first embodiment of the present invention;

FIG. 4 is a cross-sectional diagram along line A-A′ in FIG. 3 and illustrates the operation of the lens in the second liquid crystal display panel according to the first embodiment at the time of 2D display;

FIG. 5 is a cross-sectional diagram along line A-A′ in FIG. 3 and illustrates the operation of the lens in the second liquid crystal display panel according to the first embodiment at the time of 3D display;

FIG. 6 is a diagram for illustrating the relationship between the sidewall of the post spacer according to the first embodiment and the direction in which the alignment film is rubbed;

FIG. 7 is a diagram for illustrating the relationship between the sidewall of the post spacer according to the first embodiment and the direction in which the alignment film is rubbed;

FIG. 8 is a cross-sectional diagram along line B-B′ in FIG. 3;

FIG. 9 is a graph for illustrating the relationship between the comb-shaped electrode and the distribution of the refractive index in the liquid crystal layer in the second liquid crystal display panel according to the first embodiment of the present invention;

FIG. 10 is a cross-sectional diagram showing an enlargement of the post spacer portion in the second liquid crystal display panel according to the first embodiment of the present invention;

FIG. 11 is a cross-sectional diagram showing an enlargement of the post spacer portion in the second liquid crystal display panel according to the first embodiment of the present invention;

FIG. 12 is a plan diagram for illustrating another structure in detail of the second liquid crystal display panel in the display device according to the first embodiment of the present invention;

FIG. 13 is a cross-sectional diagram for schematically illustrating the structure of the second liquid crystal display panel in the display device according to the second embodiment of the present invention;

FIG. 14 is a plan diagram for schematically illustrating the structure of the first substrate that forms the second liquid crystal display panel in the display device according to the third embodiment of the present invention;

FIG. 15 is a plan diagram for schematically illustrating the structure of the second substrate that forms the second liquid crystal display panel in the display device according to the third embodiment of the present invention;

FIG. 16 is a plan diagram showing one pixel in the second liquid crystal display panel according to the third embodiment of the present invention;

FIG. 17 is a cross-sectional diagram along line D-D′ in FIG. 16;

FIG. 18 is a plan diagram showing one pixel in the second liquid crystal display panel according to the first embodiment of the present invention;

FIG. 19 is a plan diagram for schematically illustrating the structure of the first substrate that forms the second liquid crystal display panel in the display device according to the fourth embodiment of the present invention;

FIG. 20 is a plan diagram for schematically illustrating the structure of the second substrate that forms the second liquid crystal display panel in the display device according to the fourth embodiment of the present invention;

FIG. 21 is a diagram showing an enlargement of the regions denoted as E and E′ in FIGS. 19 and 20 as viewed from the display side;

FIG. 22 is a cross-sectional diagram along line F-F′ in FIG. 21;

FIG. 23 is a cross-sectional diagram along line G-G′ in FIG. 21;

FIG. 24 is a diagram for schematically illustrating the structure of an information device provided with the display device according to the present invention; and

FIGS. 25A and 25B are diagrams for schematically illustrating the structure of another information device provided with the display device according to the present invention.

### DESCRIPTION OF THE EMBODIMENTS

In the following, the embodiments of the present invention are described in reference to the drawings. In the following descriptions, the same symbols are attached to the same components, and the descriptions thereof are not repeated. In addition, X, Y and Z in the figures respectively indicate the X axis, the Y axis and the Z axis.

### First Embodiment

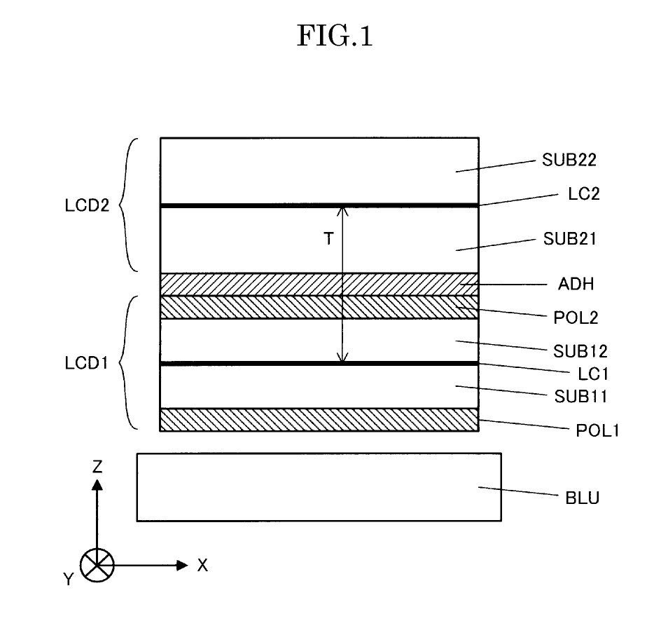

FIG. 1 is a cross-sectional diagram for illustrating the entire structure of the liquid crystal display device, which is the display device according to the first embodiment of the present invention. In the following, the entire structure of the display device according to the first embodiment is described in reference to FIG. 1. Though a case where a non-luminous type first liquid crystal display panel LCD1 is used as a display panel for displaying an image is described in the following, the display panel for displaying an image may be of another non-luminous type display panel or have a structure where a self-luminous type display panel, such as an organic EL display panel or a plasma display panel, is used.

The liquid crystal display device according to the first embodiment is formed of a first liquid crystal display panel LCD1, which is a liquid crystal display panel for displaying an image, and a second liquid crystal display panel LCD2 that functions as a lens (lenticular lens, cylindrical lens array) by controlling the refractive index for transmission light. In the liquid crystal display device that has this structure according to the first embodiment as shown in FIG. 1, the first liquid crystal display panel LCD1 and the second liquid crystal display panel LCD2 are layered in this order starting from the backlight unit (backlight device) BLU side. That is to say, the second liquid crystal display panel LCD2 is provided on the display side (viewer side) of the first liquid crystal display panel LCD1. Here, the first liquid crystal display panel LCD1 and the second liquid crystal display panel LCD2 are fixed to each other using an adhesive member ADH in order to prevent the first liquid crystal display panel LCD1 and the second liquid crystal display panel LCD2 from moving away from each other.

A member made of a well-known resin material having approximately the same refractive index as the transparent substrates (glass substrates) used as the first substrate SUB11 or SUB 21 and the second substrate SUB12 or SUB22 is used as the adhesive member ADH. In addition, the first liquid crystal display panel LCD1 and the backlight unit BLU have well-known structures, and thus, optical sheets, such as a diffuser plate, are not shown. Furthermore, the structure may be provided with a well-known protective film, a front plate and a well-known touch panel on the display side of the second substrate SUB22.

The second liquid crystal display panel LCD2 according to the first embodiment is formed of a liquid crystal display panel, for example, where liquid crystal molecules are homogeneously aligned and a pair of transparent substrates (first substrate SUB21, second substrate SUB22), such as glass substrates, are placed so as to face each other as in a well-known manner so that liquid crystal LC2 is sandwiched between the first substrate SUB21 and the second substrate SUB22. In addition, a comb-shaped electrode (first electrode, connected long, rectangular strips) is formed on the first substrate SUB21, and a common electrode (second electrode) is formed on the second substrate SUB22 in such a manner that no electrical field is applied to the liquid crystal layer LC2 when the comb-shaped electrode and the common electrode are in the same potential, and in this state, display light (display image) from the first liquid crystal display panel LCD1 transmits (passes) as it is for 2D display. In the case where different voltages are applied to the first and second electrodes, that is a so-called alternating voltage is applied while an electrical field is applied to the liquid crystal layer LC2, a parallax barrier for providing a parallax between the two eyes, where the display light from the first liquid crystal display panel LCD1 enters separately to the left and right eyes of the viewer, is provided as a lens function for 3D display (3D display for the naked eye). In this manner, the second liquid crystal display panel LCD2 according to the first embodiment operates as a liquid crystal display panel for allowing the incident light (display light) to transmit as it is in the state where no electrical field is applied to the liquid crystal. Here, the second liquid crystal display panel LCD2 is not limited to having a homogeneous alignment, but may be of another type.

The first liquid crystal display panel LCD1 according to the first embodiment is a liquid crystal display panel of a well-known IPS (in-plane switching) type and has such a structure that a pair of transparent substrates (first substrate SUB 11, second substrate SUB12), such as glass substrates, are placed in a well-known manner so as to face each other with a liquid crystal layer LC1 in between. Thin film transistors, pixel electrodes and a common electrode are formed in a well-known manner on the first substrate SUB11, and color filters and a black matrix are formed in a well-known manner on the second substrate SUB12. Here, the first substrate SUB11 is formed of a transparent substrate that is larger than the second substrate SUB12, and connection terminals for the connection to the outside are formed in a peripheral portion of the transparent substrate. As for the pasting of the first substrate SUB11 and the second substrate SUB12 together and the sealing of the liquid crystal, a well-known sealing material applied in annular form around the periphery of the second substrate SUB12 is used to paste the first and second substrates together, and this is also used to seal the liquid crystal. Furthermore, a first polarizing plate PLO1 is provided on the first substrate SUB11 on the backlight device side (on the surface facing the surface on the liquid crystal side) and a second polarizing plate PLO2 is provided on the second substrate SUB12 on the display side (on the surface facing the surface on the liquid crystal side) in such a manner that the directions of polarization of the first polarizing plate PLO1 and the second polarizing plate PLO2 form an angle of 90°. Here, the first liquid crystal display panel LCD1 is not limited to an IPS type liquid crystal display panel, but may have a structure where another type of liquid crystal display panel, such as of a TN type or a VA (vertical alignment) type, is used.

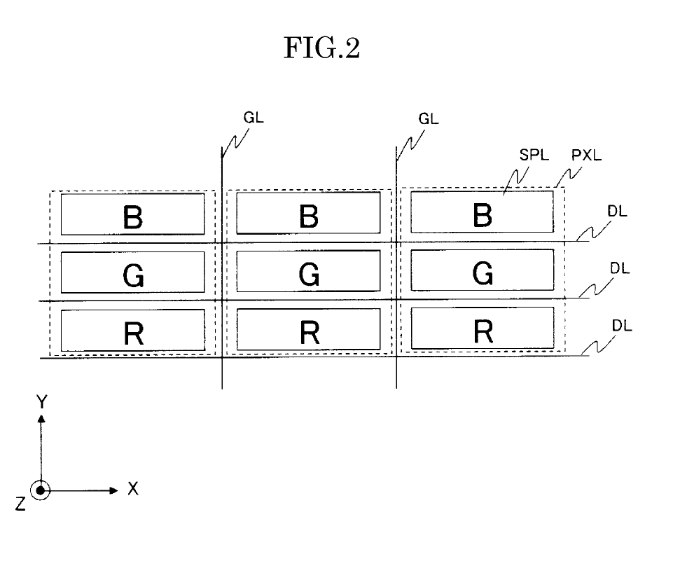

As shown in FIG. 2, gate lines GL, which run in the Y direction and are aligned in the X direction, and drain lines DL, which run in the X direction and are aligned in the Y direction, are formed within a display area on the surface of the first substrate SUB11 on the liquid crystal side in the first liquid crystal display panel LCD1 according to the first embodiment. The rectangular regions defined by the drain lines DL and the gate lines GL correspond to color filters, red (R), green (G) and blue (B), formed on the second substrate SUB12, and the pixel regions (hereinafter simply referred to as pixels) PXL made up of the three sub-pixels SPL for RGB are aligned in a matrix within the display area. In the first embodiment, a liquid crystal lens made up of cylindrical lenses is formed along the long, comb-shaped electrode PX that runs in the Y direction, and therefore, the sub-pixels SPL for RGB are aligned in the Y direction in the structure. Here, the direction in which the sub-pixels SPL for RGB are aligned is not limited to the Y direction and may be aligned differently in such a manner, for example, that the sub-pixels SPL for RGB are aligned in the X direction in the structure.

Each sub-pixel SPL is provided with a thin film transistor, not shown, that is turned on by a scanning signal from the gate line GL and a pixel electrode that is connected to the source electrode of the thin film transistor so that a gradation signal (gradation voltage) is supplied from the drain line DL through the thin film transistor when turned on. In the case of an IPS type liquid crystal display panel, a common electrode, to which a common signal having a potential that becomes the reference for the potential of the gradation signal is supplied, is provided on the first substrate SUB11 on the side where the thin film transistors are formed. In the case of a VA type or TN type liquid crystal display panel, however, a common electrode is formed on the second substrate SUB12 together with the color filters.

In the liquid crystal display panel LCD1 according to the first embodiment, the region where pixels PXL for color display are formed of sub-pixels for red (R), green (G) and blue (B) within the region where liquid crystal is sealed becomes a display area. Thus, the region where no pixels are formed and which does not relate to the display does not become a display area even within the region where liquid crystal is sealed.

<Structure of Second Liquid Crystal Display Panel>

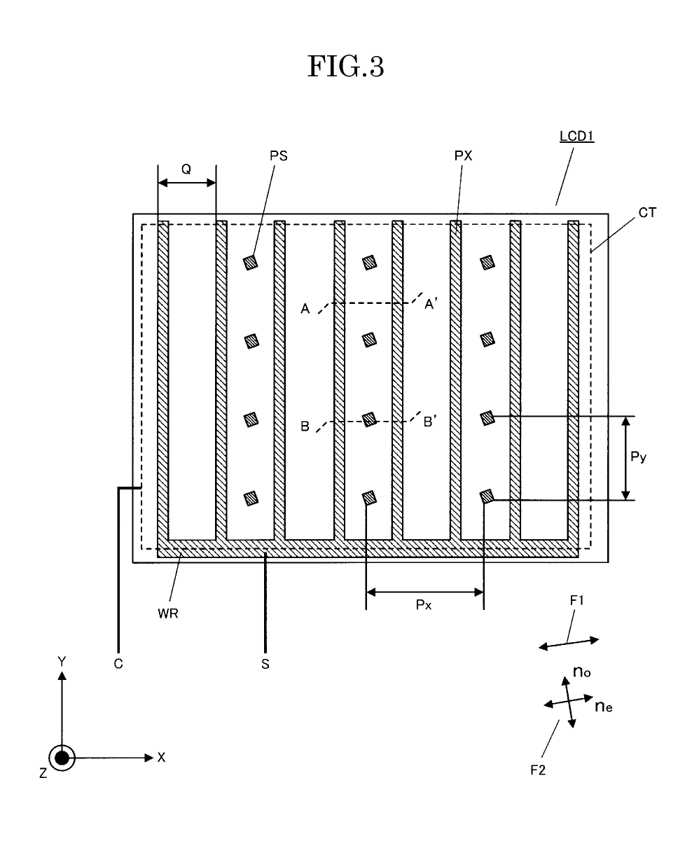

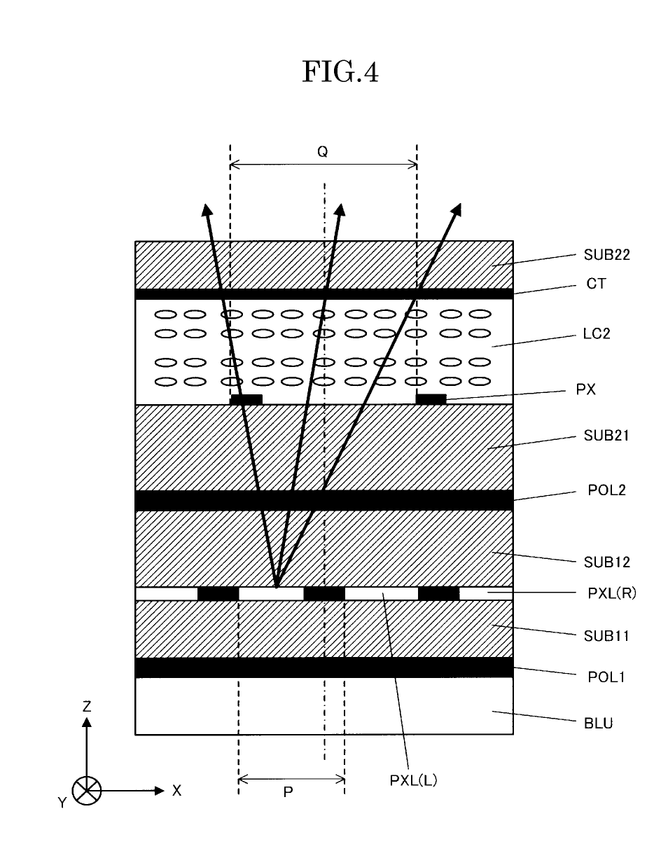

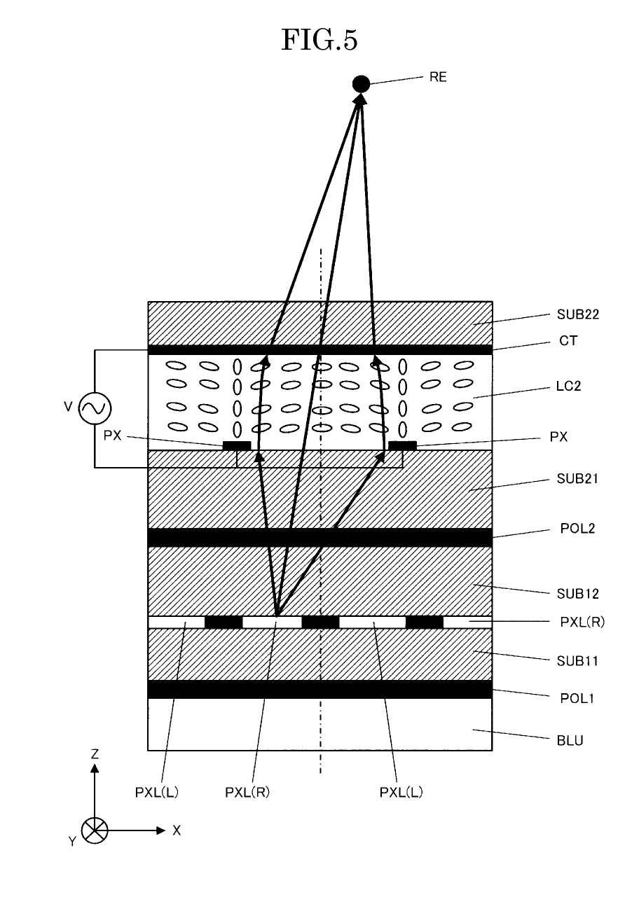

FIG. 3 is a plan diagram for illustrating the structure in detail of the second liquid crystal display panel in the display device according to the first embodiment of the present invention, and FIGS. 4 and 5 are cross-sectional diagrams along line A-A′ in FIG. 3. In particular, FIG. 3 is a diagram for illustrating the positional relationships between the comb-shaped electrode PX and post spacers (pillar spacers, column spacers, spacer members) PS, FIG. 4 is a diagram for illustrating the operation as a lens at the time of 2D display, and FIG. 5 is a diagram for illustrating the operation as a lens at the time of 3D display. In the following, the second liquid crystal display panel according to the first embodiment is described in detail in reference to FIGS. 3 to 5.

As shown in FIG. 3, a number of comb teeth electrodes PX are formed on the first substrate SUB21 on the liquid crystal side in the second liquid crystal display panel LCD2 according to the first embodiment so as to run in the Y direction and are aligned in the X direction. In addition, the wire portion WR is formed along one long side of the second liquid crystal display panel LCD2 on the first substrate SUB21 in such a manner that one end of each comb tooth electrode PX is electrically connected to this wire portion WR in the structure. The comb teeth electrodes PX and the wire portion WR are formed of an ITO-(indium tin oxide) or a ZnO (zinc oxide)-based transparent conductive film, for example. The comb teeth electrodes PX and the wire portion WR are not limited to a transparent conductive film, however, and may be formed of a conductive thin film that is not transparent, such as a metal thin film made of aluminum.

At this time, the display light from the first liquid crystal display panel LCD1, that is to say, the light that has passed through the second polarizing plate POL2, is in the direction indicated by arrow F1 in the figure, and this display light enters into the second liquid crystal display panel LCD2. Accordingly, the direction in which the light (display light) that enters into the second liquid crystal display panel LCD2 is polarized (direction in which incident light is polarized) is at 80° to 90° relative to the comb teeth electrodes PX. In addition, the liquid crystal molecules in the liquid crystal layer LC2 are aligned so as to be approximately parallel to this direction in which the incident light is polarized F1 so that attenuation of the display light when passing through the second liquid crystal display panel LCD2 can be reduced. Accordingly, a rubbing process (alignment process) for aligning the liquid crystal molecules in the liquid crystal layer LC2 approximately parallel to the direction in which the incident light is polarized is carried out on the second liquid crystal display panel LCD2. As a result, the rubbing angle in the second liquid crystal display panel LCD2 is 80° to 90° relative to the comb teeth electrodes PX so that the direction of the long axes of the liquid crystal molecules in the liquid crystal layer LC2 is aligned in the direction in which the incident light is polarized, as indicated by arrow F1. In addition, the refractive index of the liquid crystal molecules in the direction of the long axes, that is to say, in the direction of alignment, is no, as indicated by arrow F2 in the figure, and the refractive index in the direction perpendicular to this is no.

As described above, in the liquid crystal display device according to the first embodiment, the direction in which the light that enters into the second liquid crystal display panel LCD2 is polarized (direction of the transmission axis of the second polarizing plate POL2) is at an angle of 0° to 10° relative to the direction along a long side (X direction) of the second liquid crystal display panel LCD2 in which cylindrical lenses are aligned. In the case where the direction in which the light that enters into the second liquid crystal display panel LCD2 is polarized is in a desired direction as a result of linear polarization, the display mode of the first liquid crystal display panel LCD1 is not limited. In the case where the direction of polarization of the first liquid crystal display panel LCD1 is different from the desired direction as a result of linear polarization, the present invention can be applied by providing a well-known phase difference member between the second polarizing plate POL2 and the second liquid crystal display panel LCD2 so that light is polarized in a desired direction as a result of linear polarization, for example.

Post spacers PS, which are spacer members for holding the distance between the first substrate SUB21 and the second substrate SUB22 (gaps) to a predetermined value (approximately 20 μm to 100 μm), are formed in the direction in which the comb teeth electrodes PX run, that is to say, in the Y direction, in the regions between the comb teeth electrodes PX which are aligned in the X direction. These post spacers PS are formed of a photosensitive resin material, which is a material having photosensitivity, and placed in every other region between two comb teeth electrodes PX in the X direction in the structure in the first embodiment. In particular, the post spacers PS are located approximately at the center of each region between adjacent comb teeth electrodes PX in the X direction in which the comb teeth electrodes PX are aligned in order for the distance between each comb tooth electrode PX and each post spacer PS to be large. In addition, the post spacers PS in the first embodiment are placed so as to have approximately the same distance therebetween in the direction in which the comb teeth electrodes PX run, that is to say, in the Y direction, as in the X direction in order for the post spacers PS to be provided with a density as low as possible within such a range as to provide such a strength that the gap between the first substrate SUB21 and the second substrate SUB22 can be maintained. As described above, the post spacers PS are periodically placed in the structure so that it is made difficult for the viewer to see the post spacers PS.

In the case where the post spacers PS are arranged periodically, the period in the X direction Px is NQ when the period in the X direction is Px (here, N is a natural number, desirably 3 to 10, and Q is the period (pitch) of the comb teeth electrodes PX). In the case where the period in the Y direction Py is NQ, which is the same as the period in the X direction, the relative relationship between the post spacers and the pixels in the display panel are the same in the X and Y directions, which is desirable. Furthermore, Py may be equal to MQ (here, M is a natural number, desirably 3 to 10, and M≠N). In the case where there is interference between the post spacer and the pixels in the first liquid crystal display panel LCD1 due to the period in the Y direction, M may be a real number. Furthermore, the post spacers PS may be placed at random. Likewise, N may not be constant so as to be varied at random depending on the location. That is to say, the arrangement of the comb teeth electrodes PX and the spacer members SP is not limited to the structure shown in FIG. 3, and an appropriate arrangement can be selected in accordance with the size and resolution of the first and second liquid crystal display panels LCD1 and LCD2.

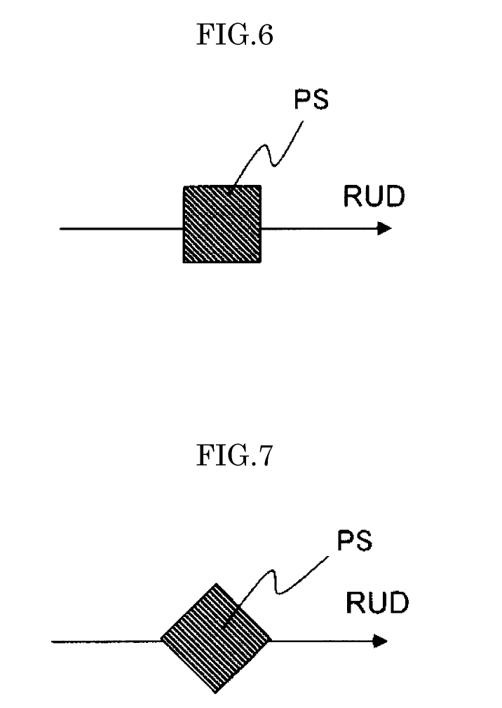

In addition, each post spacer PS is in a square column form of which the shape in the cross-section parallel to the display, that is to say, the main surface of the first substrate SUB21, is square and is placed so that a pair of sidewalls that face each other from among the sidewalls of the post spacers PS is approximately in the same direction as in the direction in which the alignment film is rubbed. That is to say, as shown in FIG. 6, the post spacer PS is placed so that one of the pairs of sidewalls of the post spacer PS that face each other is approximately perpendicular (the other of the pairs of sidewalls is approximately parallel) to the direction in which the alignment film is rubbed, which is the direction indicated by RUD in the figure. When the post spacers PS are arranged at such an angle, liquid crystal molecules in the vicinity of the sidewalls that are approximately perpendicular to the direction RUD in which the alignment film is rubbed are aligned in this direction, and thus, particular effects can be gained such that the alignment can be prevented from being disturbed due to the placement of the post spacers PS, and furthermore, the display quality can be improved.

As shown in FIG. 7, in the case where the sidewalls of a post spacer PS are at an angle of 45° relative to the direction in which the alignment film is rubbed, as indicated by the arrow RUD, for example, the direction in which the liquid crystal molecules are aligned changes so as to be perpendicular to the sidewalls in the vicinity of the sidewalls, and therefore, all the liquid crystal molecules in the vicinity of the post spacer PS are aligned in directions different from the direction in which the alignment film is rubbed RUD, and thus, light scatters. Here, the shape of the post spacers PS in the cross-section is not limited to a square and may be rectangular or polygonal, including triangular. Furthermore, post spacers PS in cylindrical form, of which the shape in the cross-section is circular, may be used in the structure, though liquid crystal molecules in the vicinity are aligned in radial form with each post spacer PS at the center.

At the time of 3D display using the second liquid crystal display panel LCD2 according to the first embodiment in the above-described structure, cylindrical lenses that run in the Y direction in regions between the comb teeth electrodes PX that are adjacent to each other are formed, and thus, an array of cylindrical lenses in lenticular form that are aligned in the X direction is formed. Here, the region in the second liquid crystal display panel LCD2 where the cylindrical lens array is formed corresponds to the display area in the first liquid crystal display panel LCD1. As a result, it is possible to direct light from different pixels, that is to say, images for different viewpoints, separately to the two eyes, left and right, of the viewer in the case where the two eyes are aligned in the X direction, and thus, stereovision is made possible in the liquid crystal display device according to the first embodiment.

<2D Display Operation and 3D Display Operation>

In the following, the display operation in the liquid crystal display device according to the first embodiment is described in reference to FIGS. 4 and 5.

In the second liquid crystal display panel LCD2 according to the first embodiment, as shown in FIGS. 4 and 5, comb teeth electrodes PX are formed on the first substrate SUB21 on the liquid crystal side, and a common electrode CT is formed on the second substrate SUB22 on the liquid crystal side. In addition, two pixels PXL are provided between comb teeth electrodes PX that are adjacent to each other in the X direction in the structure in such a manner that one pixel PXL works as a pixel PXL (L) for the left eye and the other pixel PXL works as a pixel PXL (R) for the right eye. At this time, the liquid crystal display device is formed with the pitch P of the pixels and the pitch Q of the comb teeth electrodes, which satisfy Q 2P, when the distance between the pixel PXL (L) for the left eye and the pixel PXL (R) for the right eye, that is to say, the pitch of the pixels in the X direction, is P, and the distance between the comb teeth electrodes PX that are adjacent to each other, that is to say, the pitch of the comb teeth electrodes in the X direction, is Q.

At the time of 2D display, where the difference in the potential between the comb teeth electrodes PX and the common electrode CT is 0 volts, that is to say, the same voltage is applied to the comb teeth electrodes PX and the common electrode CT, as shown in FIG. 4, liquid crystal molecules LC2 in the second liquid crystal display panel LCD2 stay in the initial alignment state. At this time, the long axes of the liquid crystal molecules in the liquid crystal layer LC2 are directed approximately parallel to the direction in which the incident light is polarized, as indicated by arrow F2 (direction of refractive index nₑ indicated by arrow F2), and thus, the liquid crystal layer LC2 does not affect the incident light so that light that has entered into the liquid crystal layer LC2 transmits as it is. As a result, display light from all of the pixels PXL in the first liquid crystal display panel LCD1 reaches both eyes, left and right, of the viewer so that a 2D display image can be seen.

Meanwhile, as shown in FIG. 5, in the case where an alternating current voltage is applied across the comb teeth electrodes PX and the common electrode CT so that an electrical field is created between each comb tooth electrode PX and the common electrode CT that arranged to face each other, the direction in which the liquid crystal molecules are aligned is controlled in accordance with the intensity of this electrical field, and thus, there is an alignment distribution in the liquid crystal layer. In this alignment distribution, the liquid crystal molecules in the regions located between a comb tooth electrode PX and the common electrode CT stand, which makes the refractive index of the liquid crystal layer LC2 in the vicinity of the comb teeth electrodes PX smaller, and thus, the liquid crystal layer LC2 works as convex lenses with the regions between the comb teeth electrodes at the centers. As a result, a number of cylindrical lenses that run in the Y direction and are aligned in the X direction are formed in the second liquid crystal display panel LCD2.

In the case of two viewpoints, pixels PXL (R) for the right eye and pixels PXL (L) for the left eye are alternately aligned in the direction in which the cylindrical lenses are aligned. As a result, as indicated by the arrow in FIG. 5, display light from the pixels PXL (R) for the right eye reaches only the right eye of the viewer, as indicated by the focal point RE in FIG. 5. Likewise, display light from the pixels PXL (L) for the left eye reaches only the left eye of the viewer. That is to say, display light from the pixels PXL (R) for the right eye and display light from the pixels PXL (L) for the left eye separately form images so as to achieve 3D display. Though a case of two viewpoints is described here, the present invention can be applied to a case of three or more viewpoints, that is, multiple viewpoints, in the same manner as in the above.

<Detailed Structure of Post Spacers>

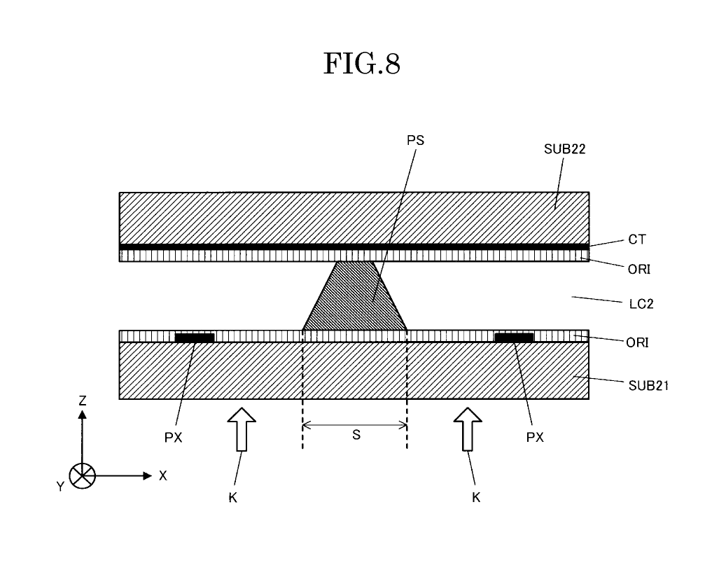

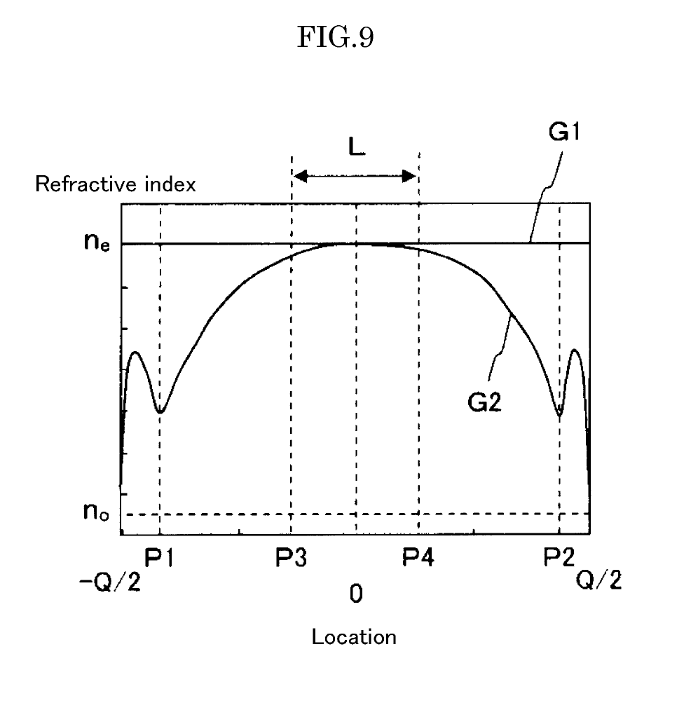

FIG. 8 is a cross-sectional diagram along line B-B′ in FIG. 3. FIG. 9 is a graph for illustrating the relationship between the comb teeth electrodes in the second liquid crystal display panel according to the first embodiment of the present invention and the distribution of the refractive index in the liquid crystal layer. In the following, the positional relationship between the post spacers in the second liquid crystal display panel in the first embodiment and the comb teeth electrodes PX is described in detail in reference to FIGS. 8 and 9. Here, FIG. 9 is a graph showing the results of measurement of the refractive index in the X direction of the portion between a pair of comb teeth electrodes PX for forming one cylindrical lens at the time of 2D or 3D display in the case where the center of the pair of comb teeth electrodes PX in the X direction is the reference point (0).

As shown in FIG. 8, in the second liquid crystal display panel LCD2 in the first embodiment, comb teeth electrodes PX are formed on the first substrate SUB21, into which light from the first liquid crystal display panel LCD1 (display light) K enters through the rear surface, on the liquid crystal side, and an alignment film ORI is formed so as to cover the upper surface of the comb teeth electrodes PX. In addition, post spacers PS are formed in a layer above the alignment film ORI, that is to say, on the alignment film ORI on the liquid crystal side. This structure is made possible by carrying out a well-known rubbing process after the formation of an alignment film ORI, and after that forming post spacers PS, for example. As described above in the first embodiment, post spacers PS are formed on the first substrate SUB21 so that precise positioning relative to the comb teeth electrodes PX is easy. Here, post spacers PS may be formed after the formation of the alignment film ORI, and a rubbing process may be carried out after the formation of these post spacers PS in the structure.

Meanwhile, color filters for R, G and B, not shown, are formed on the second substrate SUB22, which is arranged so as to face the first substrate SUB21 with the liquid crystal layer LC2 in between, on the liquid crystal side, and furthermore, a light blocking film, such as a well-known black matrix, is also formed if necessary. The common electrode CT is formed in a layer above these color filters or the black matrix, that is to say, on the second substrate SUB22 on the liquid crystal side, and an alignment film ORI is formed so as to cover the common electrode CT. Here, post spacers PS may be formed only on the second substrate SUB22 in the structure.

The refractive index in the second liquid crystal display panel LCD2 in the first embodiment having the above-described structure is nₑ, which is constant in a range from the section −Q/2 to the section Q/2, that is to say, in the entire region as is clearly shown by graph G1 in FIG. 9, at the time of 2D display. At this time, the same voltage is applied to the comb teeth electrodes PX and the common electrode CT so that no electrical field is created between the comb teeth electrodes PX and the common electrode CT in the structure. As a result, liquid crystal molecules are maintained in the state of the initial alignment, where the refractive index of the second liquid crystal display panel LCD2 is nₑ, which is constant.

Meanwhile, at the time of 3D display where different voltages are applied to the comb teeth electrodes PX and the common electrode CT so that an electrical field is applied through the liquid crystal layer LC2, the refractive index is distributed symmetrically relative to the X direction (between left and right in the figure) with the location 0 at the center, as is clear from graph G2, and thus, a cylindrical lens that runs in the Y direction is formed.

In the sections P3 and P4, which are the sections away from the comb teeth electrodes PX, that is to say, in the vicinity of the center point “0” between the pair of comb teeth electrodes PX (in the vicinity of the optical axis of the cylindrical lens) in particular, liquid crystal molecules stay lying even at the time of 3D display, as is clear from FIG. 9, and thus, the refractive index thereof changes little and has a value close to the refractive index nₑ. Accordingly, in the case where post spacers PS having a refractive index nₑ are provided in the region from section P3 to section P4, it is possible to make a change in the difference in the refractive index between the post spacers PS and the liquid crystal layer LC2 small. As a result, even when 2D display and 3D display are switched, scattering of light (display light) from the post spacers PS can be greatly suppressed so that the post spacers PS can be prevented from being seen by the viewer, and the display quality at the time of 2D or 3D display can be improved. Furthermore, scattering of light form the post spacers PS can be greatly suppressed, and therefore, cross talk of display light at the time of 3D display, that is to say, cross talk between display light for the right eye and display light for the left eye can be reduced, and the quality of 3D display (stereoscopic vision, 3D vision) can also be improved.

In the regions between section −Q/2 and section P1 as well as between section P2 and section Q/2, the comb teeth electrodes PX and the common electrode CT face each other with the liquid crystal layer LC2 in between. Accordingly, at the time of 3D display, liquid crystal molecules stand in the vicinity of the comb teeth electrodes PX due to the electrical field applied across the comb teeth electrodes PX and the common electrode CT, which makes the refractive index smaller. As a result, the refractive index in the portions above the comb teeth electrodes PX has a value close to that of the refractive index nₒ. At this time, disclination, that is to say, disturbance in the alignment of liquid crystal molecules, easily occurs in the vicinity of the comb teeth electrodes PX, and this disturbance in the alignment makes the distribution of the refractive index complex.

In the second liquid crystal display panel LCD2 in the first embodiment, it is more difficult to see the post spacers 2 both at the time of 2D display and at the time of 3D display when the refractive index nₛₚ of the post spacers PS has a value close to that of the refractive index nₑ of the liquid crystal so that the difference in the refractive index is small. Particularly when the refractive index of the post spacers PS is smaller than nₑ, total reflection occurs in the interface between the post spacers PS and the liquid crystal, which makes it easy to see the post spacers PS. The angle at which a light beam enters into a post spacer PS that is placed at the center of the liquid crystal lens from an end of a pixel is approximately 5° to 8°, and the refractive index nₑ of the liquid crystal that is used in the liquid crystal display panel LCD2 is approximately 1.7, and therefore, it is desirable for the difference between the refractive index nₚₛ of the post spacers PS and the refractive index nₑ of the liquid crystal layer LC2 to be 0.24 or less, and it is more desirable for it to be 0.15 or less in order to prevent a light beam that enters into a post spacer PS located at the center of the liquid crystal lens from an end of a pixel from causing a total reflection. Furthermore, the angle at which a light beam enters into a post spacer PS placed at the center of the liquid crystal lens from the center of the pixel is approximately 2.5° to 4°, and therefore, it is desirable for the difference between the refractive index nₚₛ of the post spacers PS and the refractive index nₑ of the liquid crystal layer LC2 to be 0.12 or less, and it is more desirable for it to be 0.07 or less in order to prevent a light beam that enters into a post spacer PS placed at the center of the liquid crystal lens from the center of the pixel from causing a total reflection.

<Shape of Post Spacers PS in Cross-Section>

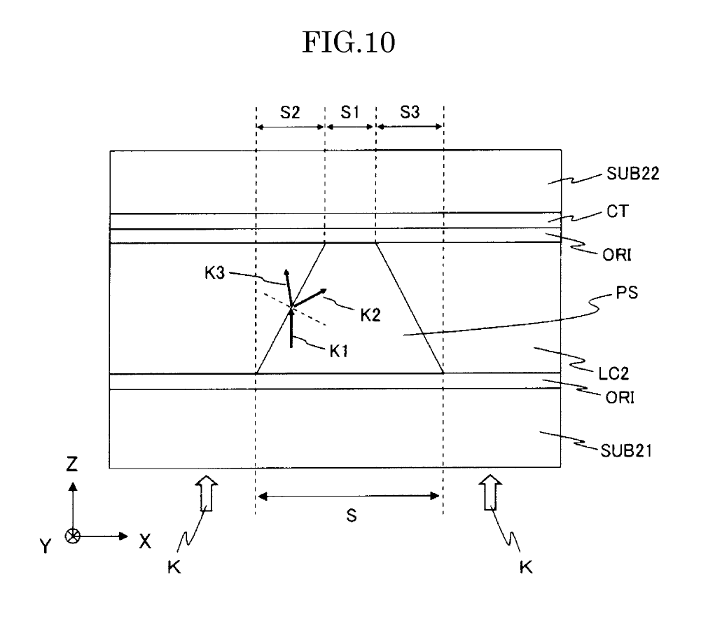

FIG. 10 is a cross-sectional diagram showing an enlargement of a portion with a post spacer according to the first embodiment of the present invention. In the following, the shape of the post spacers PS in the first embodiment in a cross-section along the XZ plane is described in reference to FIG. 10. As described above, it is preferable for the sidewalls of the post spacers PS to be parallel to the direction of the normal of the first substrate SUB21 during the process for forming the post spacers PS. However, it is difficult for the sidewalls of all the post spacers PS to be parallel to the direction of the normal because of variations during manufacture. Therefore, inconsistency in etching for the formation of the post spacers PS is taken into consideration in the first embodiment, and thus, the post spacers PS are formed in such a manner that the bottom portion is greater than the top portion, and the refractive index nₚₛ of the post spacers PS is regulated in the structure. The details are described in the following.

As is clear from FIG. 10, the post spacers PS in the first embodiment are formed so that the width 51 on the top side, that is to say, on the second substrate SUB22 side, is smaller than the width S on the bottom side, that is to say, on the first substrate SUB21 side, and the area on the top side is smaller than that on the bottom side, and therefore, more light enters into the post spacers PS from among display light K that enters into the first substrate SUB21 through the rear surface. Thus, it is desirable for light that has directly entered into the post spacers PS through the first substrate SUB21 to exit into the liquid crystal layer LC2 through the interface between the post spacers PS and the liquid crystal layer LC2, that is to say, through the sidewalls of the post spacers PS.

In the case where the display light in the post spacers PS (indicated by arrow K1 in FIG. 10) reaches the interface between the liquid crystal layer LC2 and the post spacers PS, part of the display light is usually reflected as reflection light (indicated by arrow K2 in FIG. 10) so as to go back into the post spacers PS, and the rest enters into the liquid crystal layer LC2 as transmission light (indicated by arrow K3 in FIG. 10). At this time, a total reflection can be prevented from occurring at the interface in the case where the refractive index nₚₛ of the post spacers PS is equal to or less than the refractive index nₑ of the liquid crystal layer LC2, and therefore, it is preferable for the post spacers PS to be formed of a material that satisfies nₚₛ≧nₑ.

In the case where the refractive index nₚₛ of the post spacers PS is greater than the refractive index nₑ of the liquid crystal layer LC2, the ratio of light K1 that has entered into the post spacers PS and has reached the interface being reflected from the interface increases. Furthermore, there is a critical angle for a total reflection of light K1 that has reached the interface in such a manner that light K1 that has hit the interface at an incident angle no smaller than this critical angle is totally deflected, and light that has hit at an incident angle no greater than the critical angle is refracted at a large angle, and thus, light is greatly scattered in the vicinity of the post spacers PS. In particular, the bottom (width 5) of the post spacers PS is greater than the top (width S1). Therefore, in the case where the light that has entered into the post spacers PS is greatly reflected from the interface, the light inside the post spacers PS is collected on the top side so as to exit through the top side, which is brighter than the surrounding area. Furthermore, regions S2 and S3 within the regions in the vicinity of the post spacers PS are particularly darker than the peripheral area outside of these. As a result, in the case where the refractive index nₚₛ of the post spacers PS is greater than the refractive index nₑ of the liquid crystal layer LC2, the post spacers PS can be easily seen, and at the same time, the display quality at the time of 2D display and at the time of 3D display lowers due to light scattering. In order to prevent these effects and improve the display quality, it is preferable for the refractive index nₚₛ of the post spacers PS to be no greater than the refractive index nₑ of the liquid crystal layer LC2.

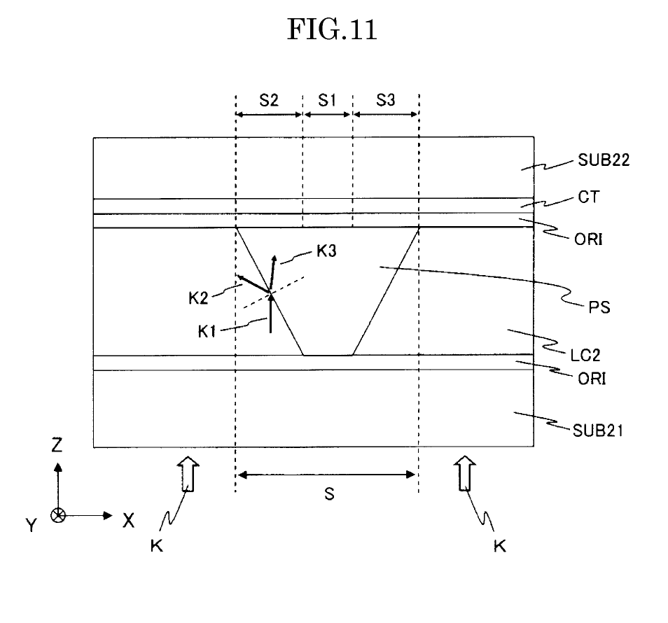

As shown in FIG. 11, the second liquid crystal display panel LCD2 in the first embodiment may have such a structure that the area of the post spacers PS on the bottom side is smaller than that on the top side. In this case, part of the display light (indicated by arrow K4 in FIG. 11) that has reached the interface between the post spacers PS and the liquid crystal layer LC2 from the liquid crystal layer LC2 is reflected as reflection light (indicated by arrow K5 in FIG. 11) so as to go back into the liquid crystal layer LC2 while the rest enters into the post spacers PS as transmission light (indicated by arrow K6 in FIG. 11). At this time, a total reflection can be prevented from occurring at the interface in the case where the refractive index nₚₛ of the post spacers PS is equal to or greater than the refractive index nₑ of the liquid layer LC2, and therefore, it is preferable for the post spacers PS to be formed of a material having a translucency that satisfies nₚₛ>nₑ. As a result, even in the case where the post spacers PS have such a shape that the top side is greater than the bottom side, the regions S2 and S3 ranging from the bottom side to the top side are darker than the other regions within the pixel area and the post spacers PS can be easily seen, and the display quality at the time of 2D display as well as at the time of 3D display can be prevented from lowering due to light scattering.

Though the post spacers PS in the first embodiment have such a structure that the size (thickness) varies between the top side and the bottom side, it is desirable for the entire portion ranging from the top side to the bottom side to vary a little. When the size varies a little in this manner, it is possible to reduce light scattering from the post spacers PS. As a result, the display quality at the time of 2D display and at the time of 3D display can be improved. In addition, cross talk of the display light at the time of 3D display, that is to say, cross talk between the display light for the right eye and the display light for the left eye, can be reduced, and thus, the 3D display quality can be improved.

In addition, the post spacers PS are formed in regions between the comb teeth electrodes PX that are aligned next to each other, that is to say, in regions through which the display light from the first liquid crystal display panel LCD1 transmits, and therefore, it is desirable for the thickness of the post spacers PS, in particular, the width S in the X direction, to be smaller. Furthermore, it is desirable for the aspect ratio, which is the ratio of the height of the post spacers PS to the width S in the X direction, to be greater.

The post spacers PS having the above-described structure can be formed of a well-known light sensitive material, and therefore can be formed using a well-known photolithographic technology. Here, the post spacers 2 may be formed through printing, such as screen printing or ink jet printing.

Though post spacers PS having a rectangular shape in a cross-section are described in the second liquid crystal display panel LCD2 in the first embodiment, there are no limitations to this, and cylindrical post spacers may be used in the structure, for example. In addition, an alignment process may be carried out on the sidewalls of the post spacers PS in the structure.

As described above, the display device according to the first embodiment is formed in such a manner that the second liquid crystal display panel LCD2 is provided on the first liquid crystal display panel LCD1 for displaying an image in accordance with an external video signal on the display side. The second liquid crystal display panel LCD2 is formed of a first substrate SUB21 and a second substrate SUB22 that are placed so as to face each other with a liquid crystal layer LC2 in between. Comb teeth electrodes that run in the Y direction and are aligned in the X direction, which crosses the Y direction, are formed on the first substrate SUB21, and one end of each comb tooth electrode is electrically connected to a wire formed along a side of the first substrate SUB21. Furthermore, post spacers PS are formed in regions away from the comb teeth electrodes, and the post spacers PS have a refractive index nₚₛ similar to the refractive nₑ of the liquid crystal layer LC2 in the structure. As a result, it is possible to make smaller the difference in the refractive index between the post spacers PS and the liquid crystal layer LC2 at the time of 2D display and at the time of 3D display, that is to say, the difference in the refractive index between the two sides of the interface, and thus, light scattering from the interface can be greatly suppressed. As a result, the post spacers PS can be prevented from being seen by the viewer, and at the same time, the display quality at the time of 2D display and at the time of 3D display can be improved. Furthermore, light scattering from the post spacers PS can be suppressed, and thus, the 3D display quality can be improved.

Furthermore, the second liquid crystal display panel LCD2 in the first embodiment is formed such that the post spacers PS are formed in locations away from the comb teeth electrodes PX, and therefore, such particular effects can be gained that it is possible to prevent the alignment of liquid crystal molecules from being disturbed in the vicinity of the comb teeth electrodes PX due to the post spacers PS and the display quality can further be improved.

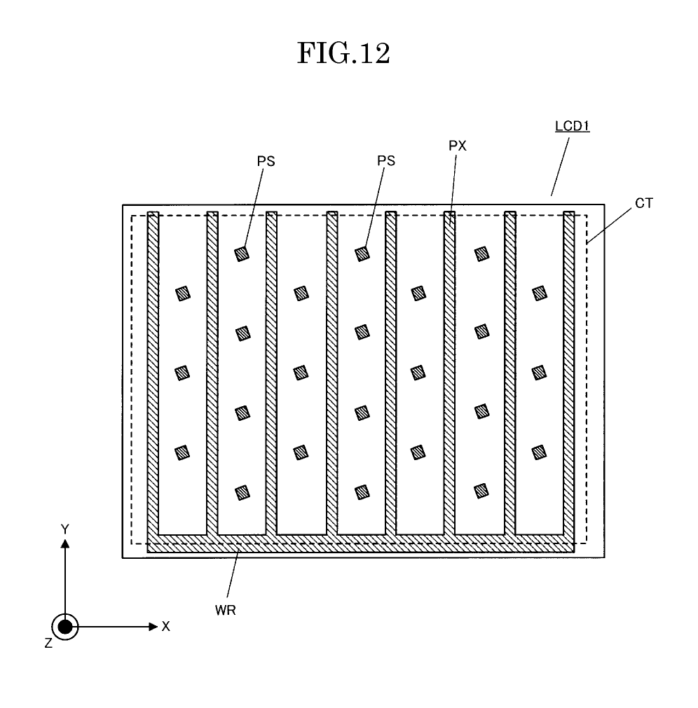

Though the second liquid crystal display panel LCD2 in the first embodiment is formed in such a manner that the post spacers PS are aligned in the direction in which the comb teeth electrodes PX run (Y direction), the alignment of the post spacers PS is not limited to this. As shown in FIG. 12, post spacers PS may be aligned and staggered in the direction in which the comb teeth electrodes PX run in the structure, for example.

### Second Embodiment

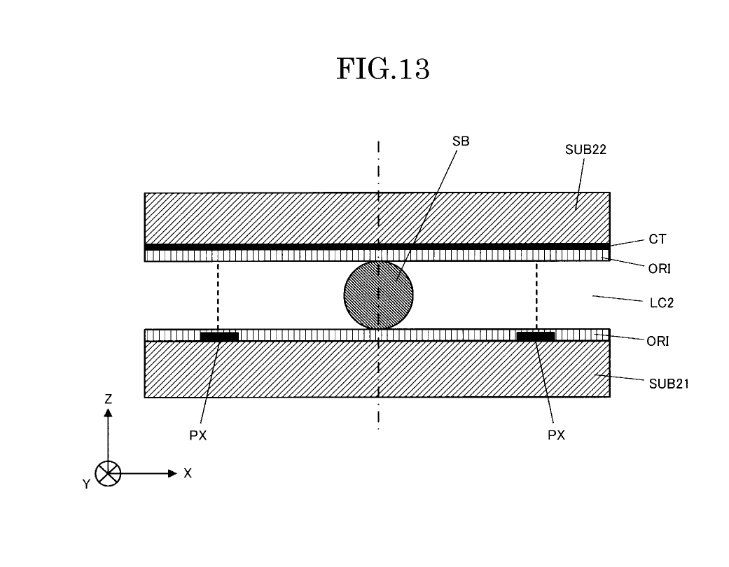

FIG. 13 is a cross-sectional diagram for schematically illustrating the structure of the second liquid crystal display panel in the display device according to the second embodiment of the present invention and corresponds to FIG. 8 of the first embodiment. Here, the structure of the display device according to the second embodiment is the same as that in the first embodiment, except for the structure of the second liquid crystal display panel LCD2. Accordingly, the structure of the second liquid crystal display panel LCD2 is described below in detail.

As shown in FIG. 13, the second liquid crystal display panel LCD2 in the second embodiment is formed using spacer beads SB, which are spherical spacers, as the spacers (spacer members). In the case where spacer beads SB are simply used, the display light is scattered by the spacer beads SB, which lowers the image quality in the same manner as in the second liquid crystal display panel LCD2 according to the prior art. Accordingly, in the second liquid crystal display panel LCD2 in the second embodiment, the locations in which the spacer beads SB are placed are regulated in order to make it possible to use the spacer beads SB as the spacers.

As described above, according to the present invention, spacer beads SB are placed in locations away from the comb teeth electrodes PX, that is to say, in regions where the refractive index changes a little at the time of 2D display and at the time of 3D display, and at the same time, the spacer beads SB are formed of a material having a similar refractive index to that of the liquid crystal when no voltage is applied. As a result, the image quality can be prevented from lowering when spacer beads SB for supporting the gap that is greater than that in the first liquid crystal display panel LCD1, which is a liquid crystal display panel for display, are provided.

At this time, in the second liquid crystal display panel LCD2 in the second embodiment, it is possible to place the spacer beads SB in desired locations, which are locations away from the comb teeth electrodes PX, by forming the spacer beads SB using an ink jet printer or providing the spacer beads SB using a printing technique, such as screen printing. In the case where an ink jet printer is used to form spacer beads SB in the center portions between pairs of comb teeth electrodes PX, that is to say, in the center regions of the cylindrical lenses (in the vicinity of optical axes of cylindrical lenses), for example, the ink jet printer is used to form spacer beads SB directly onto the main surface of the first substrate SUB21. Here, the method for providing spacer beads SB to the center regions between the comb teeth electrodes PX is not limited to this. Another example is a method for securing spacer beads SB to desired locations by scattering spacer beads PS after forming adhesive members for spacer beads SB in locations in which the spacer beads SB are to be placed by means of an ink jet printer or screen printing.

In addition, the spacer beads SB in the second embodiment are also formed of a resin material having a refractive index similar to the refractive index nₑ of the liquid crystal as the post spacers PS in the first embodiment.

As described above, the second liquid crystal display panel LCD2 in the second embodiment is also formed in such a manner that spacer beads SB having a refractive index similar to that of the liquid crystal LC2 are provided in the vicinity of the optical axes of the cylindrical lenses, and therefore, the same effects as in the first embodiment can be gained. In addition, no photographic processes for forming and providing spacer beads SB are required in the second liquid crystal display panel LCD2 in the second embodiment, and therefore, such particular effects that the second liquid crystal display panel LCD2 can be easily manufactured can be gained.

### Third Embodiment

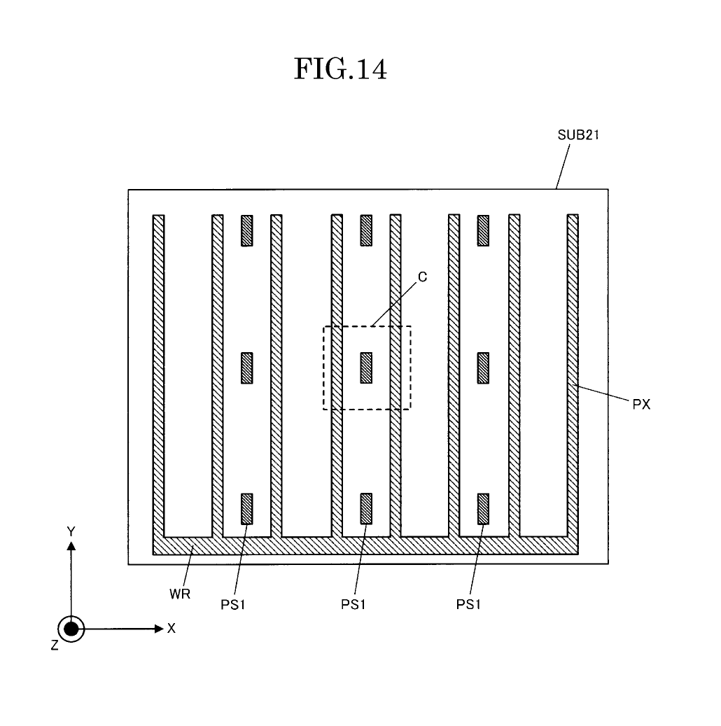

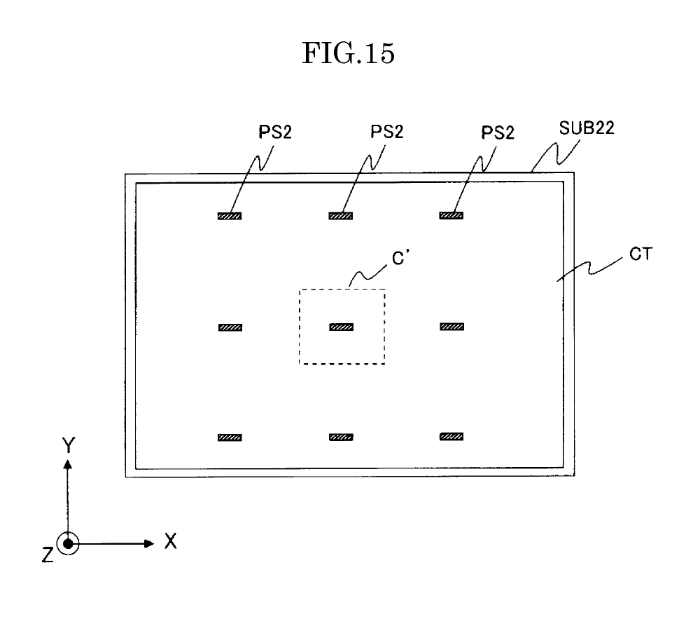

FIGS. 14 and 15 are diagrams for schematically illustrating the structure of the second liquid crystal display panel in the display device according to the third embodiment of the present invention. In particular, FIG. 14 is a plan diagram for schematically illustrating the structure of the first substrate SUB21 for forming the second liquid crystal display panel LCD2, and FIG. 15 is a plan diagram for schematically illustrating the structure of the second substrate SUB22 for forming the second liquid crystal display panel LCD2.

As is clear from FIGS. 14 and 15, the second liquid crystal display panel LCD2 in the third embodiment is formed such that post spacers PS1 and PS2 are respectively formed on the first substrate SUB21 and the second substrate SUB22, which are placed so as to face each other with a liquid crystal layer LC2 in between, on the liquid crystal side. At this time, the post spacers PS1 and PS2 in the third embodiment are formed as plates where the shape in a cross-section is rectangular in such locations that the post spacers PS1 on the first substrate SUB21 and the post spacers PS2 on the second substrate SUB22 meet when the first substrate SUB21 and the second substrate SUB2 are pasted together.

In the same manner as in the first embodiment, the post spacers PS1 and PS2 are formed between adjacent comb teeth electrodes PX, and in particular, in regions away from the comb teeth electrodes PX, which is in the vicinity of the centers between the comb teeth electrodes PX in the X direction. That is to say, the post spacers PS2 are formed in such locations as to face the post spacers PS1, and the upper surface of the post spacers PS1 and the upper surface of the post spacers PS2 make contact with each other when the first substrate SUB21 and the second substrate SUB22 are pasted together, and thus, the gap between the first substrate SUB21 and the second substrate SUB22 is maintained at a predetermined distance. Here, the post spacers PS1 and PS2 are both made of a translucent material having a refractive index of nₑ.

In particular, as shown in FIG. 14, the cross-section of the post spacers PS1 in the third embodiment is long in the longitudinal direction, which is approximately parallel to the direction in which the comb teeth electrodes PX run, which is the Y direction, that is, to the longitudinal axes of the cylindrical lenses. In addition, the post spacers PS2 in the third embodiment are formed such that, as shown in FIG. 15, the longitudinal direction of the cross-section of the post spacers PS2 is in such a direction as to cross the longitudinal direction of the post spacers PS1 (at an angle of 90°), that is to say, the longitudinal direction is the X direction. This structure allows the upper surface of the post spacers PS1 and the upper surface of the post spacers PS2 to make contact with each other when the first substrate SUB21 and the second substrate SUB22 are pasted together so that the post spacers PS1 and the post spacers PS2 maintain the gap between the first substrate SUB21 and the second substrate SUB22 at a predetermined distance.

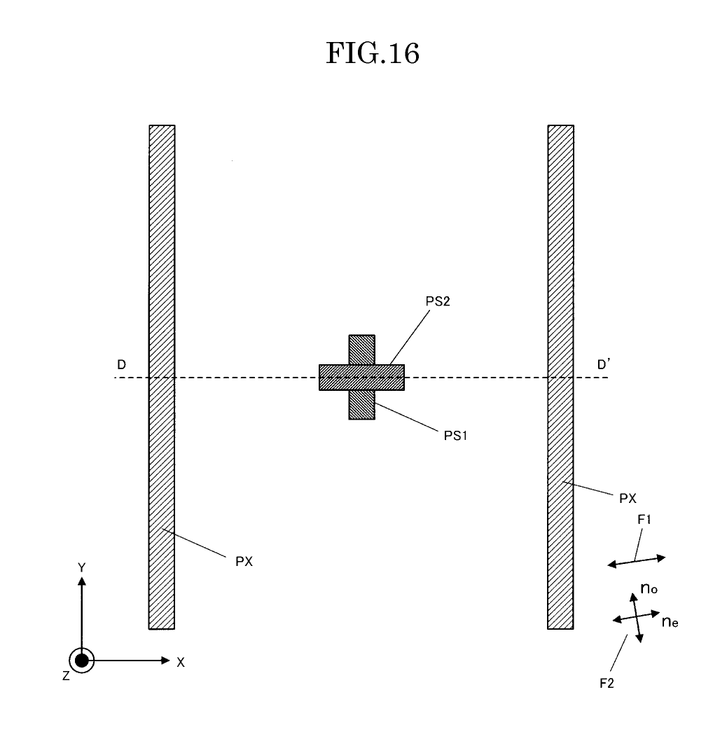

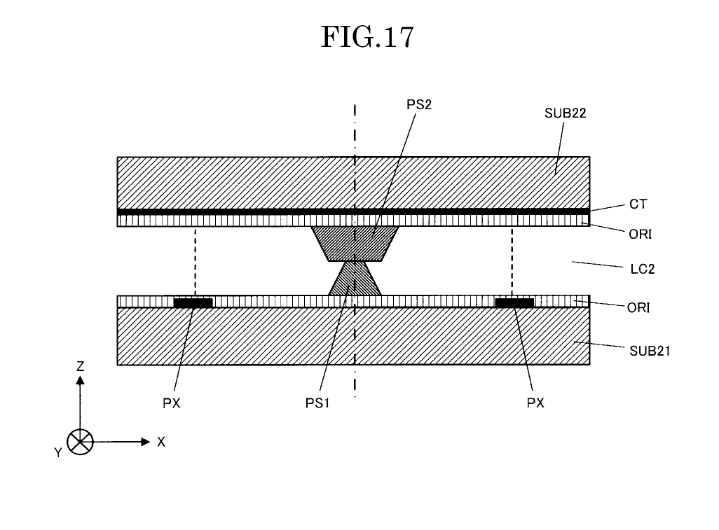

FIGS. 16 and 17 show the state of the first substrate SUB21 and the second substrate SUB22 pasted together. FIG. 16 is a plan diagram showing the second liquid crystal display panel LCD2 in the third embodiment, and FIG. 17 is a cross-sectional diagram along line D-D′ in FIG. 16. As shown in FIGS. 16 and 17, in the second liquid crystal display panel LCD2 in the third embodiment, the post spacers PS1 on the first substrate SUB21 and the post spacers PS2 on the second substrate SUB22 are located so as to meet when the first substrate SUB21 and the second substrate SUB22 are pasted together. That is to say, the post spacers PS1 and PS2 are respectively formed in such locations that the upper surface of the post spacers PS1 and the upper surface of the post spacers PS2 make contact with each other. At this time, as is clear from FIG. 16, the longitudinal directions of the post spacers PS1 formed on the first substrate SUB21 and the post spacers PS2 formed on the second substrate SUB22 cross at a right angle in the structure where they meet, that is to say, the post spacers PS1 and the post spacers PS2 make contact with each other, which forms a cross. As a result, it is possible to give more tolerance to the precision in the positioning in the X and Y directions when the first substrate SUB21 and the second substrate SUB22 are pasted together. It is also possible to give tolerance to the precision in the positioning when the post spacers PS1 and PS2 are formed, and thus, it is possible to paste the first substrate SUB21 and the second substrate SUB22 in the third embodiment together with the same precision in the positioning of the second liquid crystal display panel LCD2 as in the prior art.

FIG. 17 is a cross-sectional diagram along the longitudinal direction of a post spacer PS2, for example, and therefore, the first substrate SUB21 and the second substrate SUB22 can be positioned with a tolerance within the width of the post spacer PS2 in the X direction so that the upper surface of the post spacer PS1 and the upper surface of the post spacer PS2 make contact with each other, and the first substrate SUB21 and the second substrate SUB22 can be maintained so as to have a predetermined gap. Likewise, the post spacer PS1 has a tolerance in the longitudinal direction for the precision in the positioning in the Y direction. Accordingly, the first substrate SUB21 and the second substrate SUB22 can be positioned with a tolerance within the width of the post spacer PS1 in the Y direction so that the upper surface of the post spacer PS1 and the upper surface of the post spacer PS2 are made to make contact with each other, and thus, the first substrate SUB21 and the second substrate SUB22 can be maintained so as to have a predetermined gap.

As described above, the second liquid crystal display panel LCD2 in the third embodiment is formed so as to maintain the gap between the first substrate SUB21 and the second substrate SUB22 at a predetermined distance by using the two types of post spacers PS, the post spacers PS1 formed on the first substrate SUB21 and the post spacers PS2 formed on the second substrate SUB22. This structure makes it possible for the post spacers PS1 and PS2 formed on the first substrate SUB21 and on the second substrate SUB22 to have a height half of the gap. As a result, it is possible to shorten the time required for the formation of the post spacers PS1 and PS2 that require a height corresponding to the gap in the second liquid crystal display panel LCD2, which is greater than the gap in the first liquid display panel LCD1. Furthermore, in the case where a rubbing process is carried out on the alignment film ORI after the formation of the post spacers PS1 and PS2, it is possible for a smaller force to be applied to the post spacers PS1 and PS2, and therefore, it is possible to increase the reliability of the post spacers PS1 and PS2.

Furthermore, two types of post spacers PS1 and PS2 are layered on top of each other in order to maintain the gap in the structure of the third embodiment, even though the post spacers PS1 and PS2 are formed in such a manner that the sidewalls incline at the same angle as that in the first embodiment. Accordingly, it is possible for the post spacers PS1 and PS2 to have a smaller volume without expanding the area of the post spacers PS1 and PS2 in a plane.

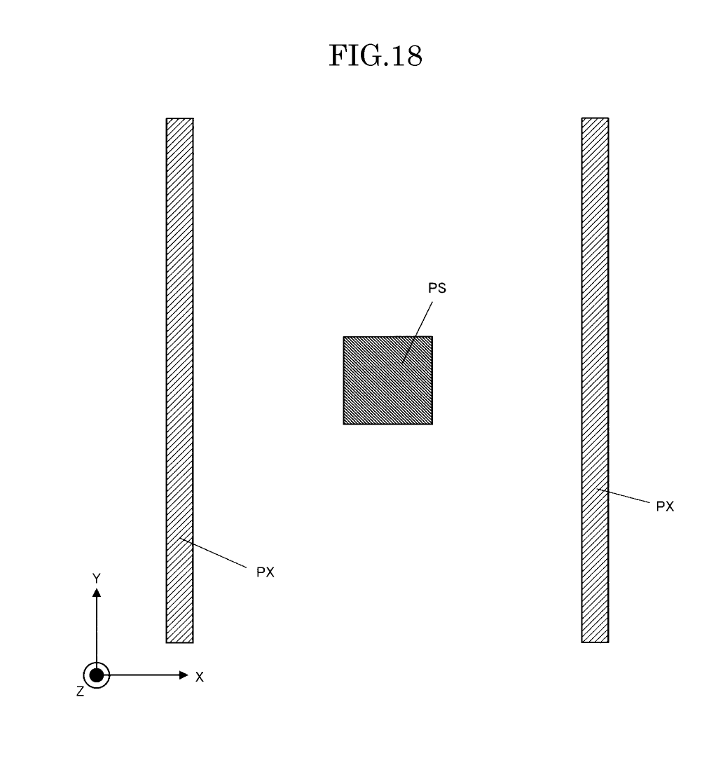

In the case where the post spacers PS in the first embodiment and the post spacers PS1 and PS2 in the third embodiment have the same aspect ratio, the area for installing post spacers can be reduced by providing post spacers with a shorter height. In the third embodiment, post spacers PS1 and PS2 are provided to the upper and lower substrates (first substrate SUB21 and second substrate SUB22) in the structure. Accordingly, the height of the post spacers PS1 and PS2 can be ½ of that of the post spacers PS in the first embodiment, where FIG. 18 shows the area for installing a post spacer PS having the structure according to the first embodiment. As a result, the corner portions of the post spacer PS in the first embodiment shown in FIG. 18 are unnecessary for the post spacers PS1 and PS2 in the third embodiment, of which the area for installment can be reduced to ¼ at the maximum. Thus, the area for installing the post spacers PS1 and PS2 and the volume of the post spacers PS1 and PS2 can be small in the structure in the third embodiment, and therefore, light can be scattered a little. As a result, particular effects can be gained such that the light scattering caused by the post spacers PS1 and PS2 can further be reduced, and the display quality can further be improved. In addition, the reduction in the height of the post spacers PS1 and PS2 makes it easier to fabricate the post spacers PS1 and PS2.

As in the first embodiment, the direction in which the display light from the first liquid crystal display panel LCD1 is polarized (the direction in which the incident light to the second liquid crystal display panel LCD2 is polarized) is at 80° to 90° relative to the comb teeth electrodes PX in the second liquid crystal display panel LCD2 in the third embodiment, as indicated by the arrow in the figure. That is to say, the first substrate SUB21 is formed such that the direction of the initial alignment is the same as in the direction in which the incident light is polarized. At this time, the refractive index of the liquid crystal layer LC2 is nₑ, even in the case where the electrical field between the comb teeth electrodes PX and the common electrode CT is zero, and the refractive index in the vicinity of the comb teeth electrodes PX is nₒ when an electrical field is applied.

Though the post spacers PS1 and PS2 in the third embodiment are formed such that the area on the bottom is greater than that on the top, the structure is not limited to this, and one or both of the post spacers PS1 and PS2 may be formed such that the area on the top is greater than that on the bottom. Though the height of the post spacers PS1 and the height of the post spacers PS2 are the same in the above description, the structure is not limited to this, and they may have different heights.

### Fourth Embodiment

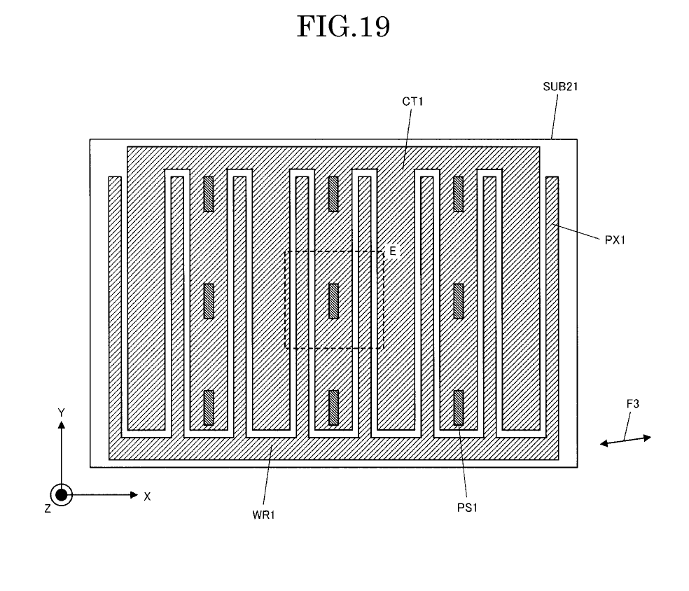

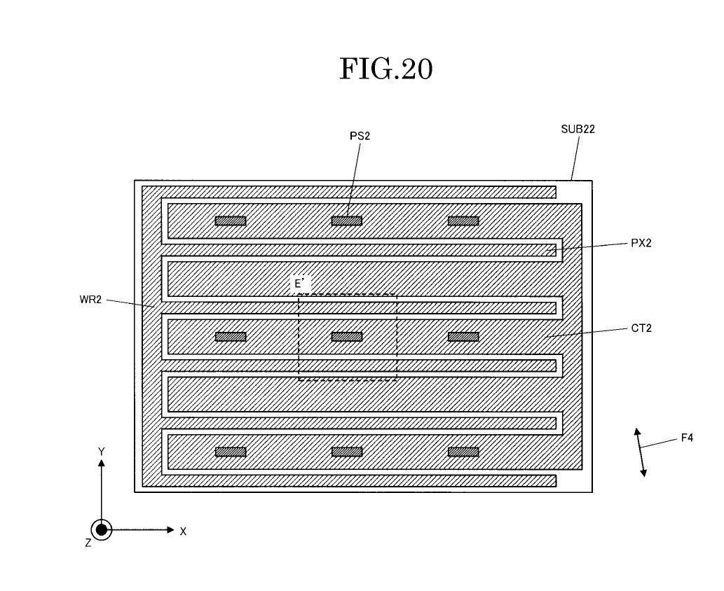

FIG. 19 is a plan diagram for schematically illustrating the structure of the first substrate for forming the second liquid crystal display panel in the display device according to the fourth embodiment of the present invention. FIG. 20 is a plan diagram for schematically illustrating the structure of the second substrate for forming the second liquid crystal display panel in the display device according to the fourth embodiment of the present invention.

As is clear from FIG. 19, the first substrate SUB21 in the fourth embodiment is formed such that the comb teeth electrodes PX1 are made of a transparent conductive film, such as of ITO, run in the Y direction and are aligned in the X direction, and one end of each is electrically connected to a wire portion WR1 that runs in the X direction. In addition, in the fourth embodiment, a common electrode CT1 made of a transparent conductive film, such as of ITO, is formed in the region excluding the region in which the comb teeth electrodes PX1 and the wire portion WR1 are formed at least within the display area in such a manner that the common electrode CT1 is away from the comb teeth electrodes PX1 and the wire portion WR1 by a predetermined distance in the structure. At this time, as described below in detail, the comb teeth electrodes PX1, the wire portion WR1 and the common electrode CT1 are formed in the same layer.

In addition, the first substrate SUB21 in the fourth embodiment is formed such that part of the common electrode CT1 is located in each region between adjacent comb teeth electrodes PX1. At this time, an alignment film ORI is formed in a layer above the common electrode CT1, and post spacers PS1 are formed on the upper surface of the alignment film ORI in the structure. Here, the post spacers PS1 in the fourth embodiment have the same shape as those in the third embodiment and are formed in such locations as to face the below-described post spacers PS2.

Meanwhile, the second substrate SUB22 in the fourth embodiment is formed such that comb teeth electrodes PX2 run in the longitudinal direction, that is to say, the X direction, and are aligned in the width direction, that is to say, the Y direction, and a wire portion WR2 is provided along a side of the second substrate SUB22 and runs in the Y direction, where one end of each comb tooth electrodes PX2 is electrically connected to the wire portion WR2. In addition, in the same manner as in the first substrate SUB21, a common electrode CT2 is formed in the region excluding the region in which the comb teeth electrodes PX2 and the wire portion WR2 are formed, at least within the display area, where the common electrode CT2 is formed in the same layer as the comb teeth electrodes PX2 and the wire portion WR2. That is to say, in the same manner as in the first substrate SUB21, part of the common electrode CT2 is formed in each region between adjacent comb teeth electrodes PX2 in the structure. The second substrate SUB22 is also formed such that an alignment film ORI is formed in a layer above the common electrode CT2, and post spacers PS2 are formed on the upper surface of the alignment film ORI in such locations as to face the post spacers PS1. The post spacers PS2 have the same shape as those in the third embodiment.

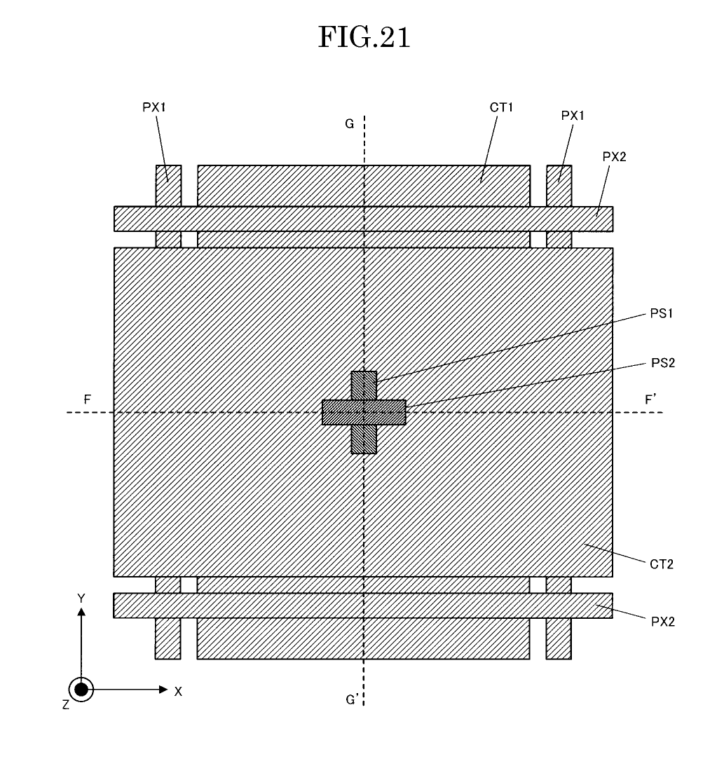

FIG. 21 is a diagram showing an enlargement of the region indicated by E and E′ in FIGS. 19 and 20 as viewed from the display side, and in particular, a front diagram showing an enlargement of the region E, E′ in the second liquid crystal display panel in such a state that the first substrate SUB21 and the second substrate SUB22 are pasted together.

As is clear from FIG. 21, in the fourth embodiment, the first substrate SUB21 and the second substrate SUB22 have comb teeth electrodes PX1 and PX2, common electrodes CT1 and CT2 as well as post spacers PS1 and PS2, respectively, in the structure. In addition, the post spacers PS1 and PS2 in the fourth embodiment are formed in regions between comb teeth electrodes PX1 as well as between comb teeth electrodes PX2 when the first substrate SUB21 and the second substrate SUB 22, which are pasted together, are viewed from the display side. Thus, it is desirable for the post spaces PS1 and PS2 to be formed at locations away from the comb teeth electrodes PX1 and PX2, and therefore, in the fourth embodiment as well, the post spacers PS1 and PS2 are formed at the centers of the regions between the comb teeth electrodes PX1 as well as between the comb teeth electrodes PX2. Furthermore, in the fourth embodiment, the post spacers PS1 are long in the Y direction in which the comb teeth electrodes PX1 run, and the post spacers PS2 are long in the X direction in which the comb teeth electrodes PX2 run, and therefore, the post spacers PS1 and the post spacers PS2 are made to make contact with each other in a cross when the first substrate SUB21 and the second substrate SUB22 are pasted together.

As shown in FIGS. 19 and 20, the first substrate SUB21 and the second substrate SUB22 in the second liquid crystal display panel LCD2 in the fourth embodiment are formed such that the direction in which the alignment film ORI is rubbed inclines relative to the comb teeth electrodes PX1 and PX2. At this time, in the fourth embodiment as well, the direction in which the first substrate SUB21 is rubbed and the direction in which the second substrate SUB22 is rubbed are perpendicular to each other in the structure. This structure regulates the initial alignment of liquid crystal molecules in the liquid crystal layer LC2 in the case where cylindrical lenses that run in the X direction are formed and in the case where cylindrical lenses that run in the Y direction are formed.

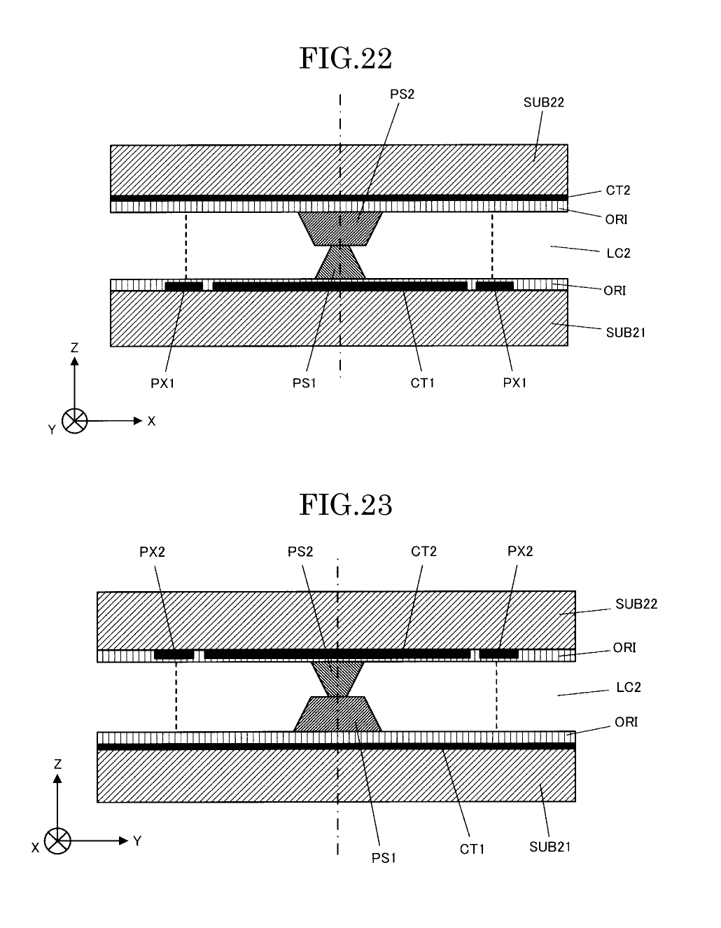

FIG. 22 is a cross-sectional diagram along line F-F′ in FIG. 21, and FIG. 23 is a cross-sectional diagram along line G-G′ in FIG. 21. In the following, the structure of the second liquid crystal display panel LCD2 in the fourth embodiment is described in detail in reference to FIGS. 21 to 23.

As is clear from FIGS. 22 and 23, the structure of the second liquid crystal display panel LCD2 in the fourth embodiment allows for the formation of first cylindrical lenses that run in the X direction and are aligned in the Y direction as well as second cylindrical lenses that run in the Y direction and are aligned in the X direction. That is to say, the structure allows for the switching between a case where 3D display is possible in the lateral position where the left and right eyes of the viewer are aligned in the X direction, which is the longitudinal direction of the second liquid crystal display panel LCD2, and a case where 3D display is possible in the longitudinal position where the left and right eyes of the viewer are aligned in the Y direction, which is the width direction of the second liquid crystal display panel LCD2.

In order to make this switching possible, the second liquid crystal display panel LCD2 in the fourth embodiment is formed such that comb teeth electrodes PX1 are aligned in the width direction (X direction) of the post spacers PS1 formed on the first substrate SUB21 and the comb teeth electrodes PX1 run in the longitudinal direction (Y direction) of the post spacers PS1. Meanwhile, comb teeth electrodes PX2 are aligned in the width direction (Y direction) of the post spacers PS2 formed on the second substrate SUB22 and the comb teeth electrodes PX2 run in the longitudinal direction (X direction) of the post spacers PS2 in the structure. Furthermore, common electrodes CT1 and CT2 are formed on the first substrate SUB21 and the second substrate SUB22, respectively, in the structure. The thus-formed first substrate SUB21 and second substrate SUB22 are placed so as to face each other with a liquid crystal layer LC2 in between so that 3D display is possible in the longitudinal direction and in the width direction.

At the time of 3D display in the longitudinal direction (lateral position), for example, a common signal which works as a reference is supplied to the common electrode CT2 and the comb teeth electrodes PX2 formed on the second substrate SUB22, and at the same time, a drive signal is supplied to the comb teeth electrodes PX1 formed on the first substrate SUB21. As a result of this operation, as in the above-described first to third embodiments, cylindrical lenses are formed between adjacent comb teeth electrodes PX1 so as to run in the direction in which the comb teeth electrodes PX1 run (Y direction) and be aligned in the X direction. At this time, neither the common signal nor the drive signal is supplied to the common electrode CT1 formed on the first substrate SUB21.

Meanwhile, at the time of 3D display in the width direction (longitudinal position), a common signal which works as a reference is supplied to the common electrode CT1 and the comb teeth electrodes PX1 formed on the first substrate SUB21, and at the same time, a drive signal is supplied to the comb teeth electrodes PX1 on the first substrate SUB21. As a result of this operation, cylindrical lenses are formed between adjacent comb teeth electrodes PX2 so as to run in the direction in which the comb teeth electrodes PX2 run (Y direction) and be aligned in the Y direction. At this time, neither the common signal nor the drive signal is supplied to the common electrode CT2 formed on the second substrate SUB22 in the structure.

Thus, in the second liquid crystal display panel LCD2 in the fourth embodiment, in the same manner as in the second liquid crystal display panel LCD2 in the third embodiment, post spacers PS1 and PS2 are formed in the center locations that are away from the adjacent comb teeth electrodes PX1 and PX2 in the structure, and therefore, the same effects as in the third embodiment can be gained. In addition, comb teeth electrodes PX1 and PX2 are formed on the first substrate SUB21 and the second substrate SUB22 in the structure, and therefore, particular effects can be gained such that 3D display is possible in either direction of the display device, the longitudinal direction and the width direction.

Though the comb teeth electrodes PX1, the wire portion WR1 and the common electrode CT1 are formed in the same layer in the fourth embodiment, the structure is not limited to this. The comb teeth electrodes PX1 and the wire portion WR1 may be formed in a layer different from the common electrode CT1 with an insulating film in between in the structure in such a manner that the comb teeth electrodes PX1 and the wire portion WR1 are formed closer to the liquid crystal layer LC2 than the common electrode CT1, for example. In this structure, it is possible for the common electrode CT1 to be formed on the entire surface within the display area on the first substrate SUB21.

### Fifth Embodiment

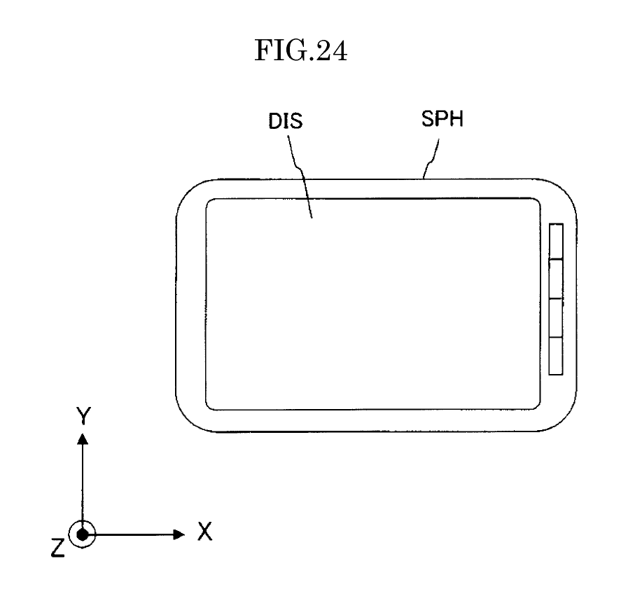

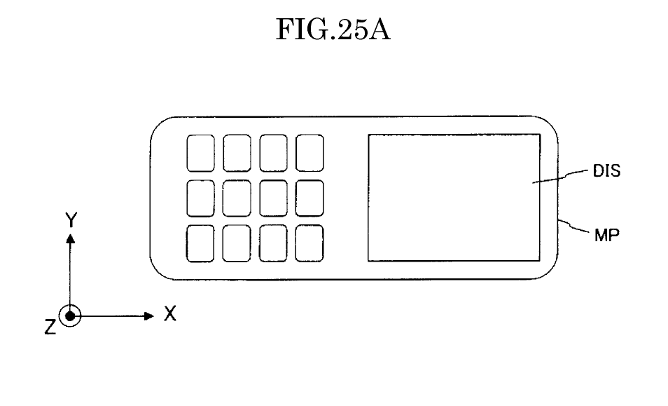

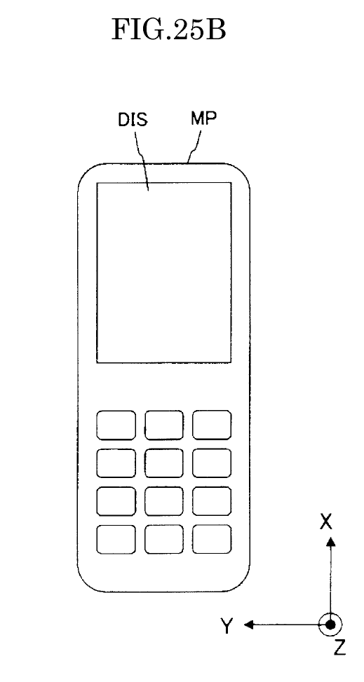

FIGS. 24 to 25B are diagrams for schematically illustrating the structure of an information apparatus having the display device according to the present invention. In particular, FIG. 24 shows a case where the display device according to the present invention is used for a portable information terminal, and FIGS. 25A and 25B show a case where the display device according to the fourth embodiment of the present invention is used in a portable phone, which is a portable information terminal.

As shown in FIG. 24, in the case where the display device DIS according to the present invention is applied to a portable information terminal SPH, such as smartphones or portable game devices, post spacers can be prevented from being seen by the viewer even in 3D display at the lateral position where the longitudinal direction is in the left to right direction. As a result, it is possible to improve the image quality at the time of 3D display.

In the case where the present invention is applied to a portable phone MP, post spacers can be prevented from being seen by the viewer both at the time of 3D display at the longitudinal position where the longitudinal direction of the display device DIS is in the upward and downward direction, as shown in FIG. 25A, and at the time of 3D display at the lateral position where the longitudinal direction of the display device DIS is in the left to right direction, as shown in FIG. 25B. As a result, it is possible to improve the image quality at the time of 3D display.

Though the display device according to the fifth embodiment of the present invention is applied to an information apparatus, the invention is not limited to this, and it is possible to apply the display device according to the present invention to other apparatuses having a display device, such as photographing devices for taking 3-dimensional videos or a television device.

Though the invention made by the present inventor is concretely described on the basis of the above-described embodiments of the invention, the present invention is not limited to these embodiments of the invention, and various modifications are possible as long as the gist of the invention is not deviated from.

What is claimed is:

1. A display device, comprising: a display panel for displaying an image; and a liquid crystal lens panel for switching a 2D display and a 3D display with each other, which is provided on a display side of said display panel and forms a parallax barrier by controlling a refractive index as in a cylindrical lens, characterized in that
said liquid crystal lens panel comprises:
a pair of transparent substrates that are placed so as to face each other with a liquid crystal layer in between;
comb-shaped electrodes, which are formed on the liquid crystal layer side of one of said transparent substrates, run in an X direction and are aligned in a Y direction;
flat common electrodes formed on the liquid crystal layer side of the other of said transparent substrates; and
post spacers having light transmitting properties for holding said pair of transparent substrates at a predetermined distance, wherein
said post spacers are fixed to one of said pair of transparent substrates on the liquid crystal side and are placed in regions away from said comb-shaped electrodes in a plane of said transparent substrate.

2. The display device according to claim 1, characterized in that said post spacers are formed in approximately a center of their adjacent comb-shaped electrodes.

3. The display device according to claim 1, characterized in that said pair of transparent substrates are provided with an alignment film for restricting an initial alignment of liquid crystal molecules in said liquid crystal layer, and
said initial alignment forms an angle in a range from 80° to 90° relative to a direction in which said comb-shaped electrodes run.

4. The display device according to claim 3, characterized in that said post spacers are in prism form, and each sidewall of the post spacers is inclined relative to a direction of said initial alignment.

5. The display device according to claim 1, characterized in that said post spacers include first post spacers formed on one of said transparent substrates and second post spacers formed on the other of said transparent substrates in such locations as to face said first post spacers in such a manner that said first post spacers and said second post spacers make contact with each other to hold said pair of transparent substrates at a predetermined distance.

6. The display device according to claim 5, characterized in that said first and second post spacers are in plate form, a longitudinal direction of said first post spacers is in the X direction and a longitudinal direction of said second post spacers is in the Y direction.

7. The display device according to claim 1, characterized in that one of said transparent substrates comprises second common electrodes in plate form that are formed in regions between said comb-shaped electrodes that are aligned in the Y direction, the other of said transparent substrates comprises second comb-shaped electrodes that run in the Y direction and are aligned in the X direction, and said common electrodes in plate form are provided in regions between the second comb-shaped electrodes.

8. The display device according to claim 7, characterized in that a refractive index of said post spacers is approximately the same as a refractive index of said liquid crystal layer at a time of the 2D display.

9. The display device according to claim 7, characterized in that said post spacers are in pillar form where an upper side is smaller than a bottom side that is fixed to said transparent substrate, and a refractive index nₚₛ of the post spacers is no greater than a refractive index nₑ of said liquid crystal layer.

10. The display device according to claim 7, characterized in that said post spacers are in pillar form where an upper side is smaller than a bottom side that is fixed to said transparent substrate, and a refractive index nₚₛ of the post spacers is no smaller than a refractive index nₑ of said liquid crystal layer.

11. The display device according to claim 7, characterized in that said display panel is formed of a liquid crystal display panel having a pair of transparent substrates that are placed so as to face each other with a liquid crystal layer in between and a backlight unit placed on a rear side of the liquid crystal display panel.
